(19) United States
(12) Patent Application Publication
(10) Pub. No.: US 2007/0227900 A1
(43) Pub. Date: Oct. 4, 2007

(54) PERFORMANCE ENHANCEMENT VIA WATER MANAGEMENT IN ELECTROCHEMICAL CELLS

(75) Inventors: Brian C. Benicewicz, Loudonville, NY (US); Glenn A. Eisman, Niskayuna, NY (US); Michael D. Gasda, West Sand Lake, NY (US); Daryl L. Ludlow, Rensselaer, NY (US)

Correspondence Address: H2 PUMP, LLC, 11 NORTHWAY LANE NORTH, LATHAM, NY, 12110, US

(73) Assignee: H2 Pump LLC, Latham, NY (US)

(21) Appl. No.: 11/696,179

(22) Filed: Apr. 3, 2007

Related U.S. Application Data
(60) Provisional application No. 60/788,985, filed on Apr. 4, 2006.
(60) Provisional application No. 60/860,564, filed on Nov. 22, 2006.

(51) Int. Cl. C25B 1/02; B01D 53/32

(52) U.S. Cl. 205/637; 205/765

(57) ABSTRACT

Techniques are provided for system operation and performance management of electrochemical cells. Electrochemical cells using polybenzimidazole (PBI) proton exchange membranes may be used. In certain embodiments, performance enhancements are achieved through water management via anode and/or cathode humidification, and reactant air injection.

### CROSS REFERENCE TO RELATED APPLICATIONS

This application claims priority under 35 USC 119(e) from U.S. Provisional Application Nos. 60/788,985, filed Apr. 4, 2006, naming Benicewicz and Eisman as inventors, and titled “WATER MANAGEMENT IN A PBI MEMBRANE ELECTROCHEMICAL DEVICE,” and 60/860,564, filed Nov. 22, 2006, naming Gasda, Ludlow, Benicewicz and Eisman as inventors, and titled “METHOD OF OPERATING AN ELECTROCHEMICAL HYDROGEN SEPARATOR AND COMPRESSOR.” These applications are incorporated herein by reference in their entirety and for all purposes.

### TECHNICAL FIELD OF THE INVENTION

The present invention relates to apparatus, methods and applications for electrochemical cells. Electrochemical cells using polybenzimidazole (PBI) proton exchange membranes may be used.

### BACKGROUND

Electrochemical technologies are of increasing interest, due in part to advantages provided in efficiency and environmental impact over traditional mechanical and combustion based technologies.

A variety of electrochemical fuel cell technologies are known, wherein electrical power is produced by reacting a fuel such as hydrogen in an electrochemical cell to produce a flow of electrons across the cell, thus providing an electrical current. For example, in fuel cells utilizing proton exchange membrane technology, an electrically non-conducting proton exchange membrane is typically sandwiched between two catalyzed electrodes. One of the electrodes, typically referred to as the anode, is contacted with hydrogen. The catalyst at the anode serves to divide the hydrogen molecules into their respective protons and electrons. Each hydrogen molecule produces two protons which pass through the membrane to the other electrode, typically referred to as the cathode. The protons at the cathode react with oxygen to form water, and the residual electrons at the anode travel through an electrically conductive path around the membrane to produce an electrical current from anode to cathode. The technology is closely analogous to conventional battery technology.

Electrochemical cells can also be used to selectively transfer (or “pump”) hydrogen from one side of the cell to another. For example, in a cell utilizing a proton exchange membrane, the membrane is sandwiched between a first electrode and a second electrode, a gas containing hydrogen is placed at the first electrode, and an electric potential is placed between the first and second electrodes, the potential at the first electrode with respect to ground (or “zero”) being greater than the potential at the second electrode with respect to ground. Each hydrogen molecule reacted at the first electrode produces two protons which pass through the membrane to the second electrode of the cell, where they are rejoined by two electrons to form a hydrogen molecule (sometimes referred to as “evolving hydrogen” at the electrode).

Electrochemical cells used in this manner are sometimes referred to as hydrogen pumps. In addition to providing controlled transfer of hydrogen across the cell, hydrogen pumps can also by used to separate hydrogen from gas mixtures containing other components. Where the hydrogen is pumped into a confined space, such cells can be used to compress the hydrogen, at very high pressures in some cases.

There is a continuing need for apparatus, methods and applications relating to electrochemical cells.

### SUMMARY OF THE INVENTION

Techniques are provided for system operation and performance management of electrochemical cells. Electrochemical cells using polybenzimidazole (PBI) proton exchange membranes may be used. In certain embodiments, performance enhancements are achieved through water management via anode and/or cathode humidification, and reactant air injection.

Various aspects and features of the invention will be apparent from the following Detailed Description and from the Claims.

### DESCRIPTION OF DRAWINGS

FIG. 1 is a graph showing comparative performance between two electrochemical cells.

FIG.2 is a graph showing comparative performance between two electrochemical cells.

### DETAILED DESCRIPTION OF THE INVENTION

It will be appreciated that the apparatus, methods, and applications of the invention can include any of the features described herein, either alone or in combination.

Embodiments under the present invention generally relate to electrochemical cells utilizing polybenzimidazole (PBI) proton exchange membranes. Various examples of PBI based electrochemical systems are provided in U.S. Pat. No. 4,814,399, which is hereby incorporated by reference. As a further example, PBI membranes used with the present invention can be prepared by a sol-gel process, as described in the article, High-Temperature Polybenzimidazole Fuel Cell Membranes Via A Sol-Gel Process, Chem. Mater. Vol. 17, No. 21, 2005, and in U.S. patent application Ser. No. 11/627,955 which are each incorporated herein by reference.

As of this writing, sol-gel based PBI membranes are generally preferred, though other types of membranes known in the art can be used. The inventors have focused on investigating new and advantageous performance characteristics of these membranes, as well as other PBI technologies and other proton exchange membrane technologies known in the art. One advantage that PBI based membranes provide is that they are capable operating at higher temperatures (e.g., 100-200 C, over 140 C, etc.) relative to more traditional polymer electrolyte membrane materials such as Nafion® (e.g., <100 C). This higher operating temperature provides tolerance to catalyst poisons like carbon monoxide that can be present in the hydrogen source gas (e.g., reformate).

PBI based materials are a class of heterocyclic polymers. When adapted for use in electrochemical cells, they are normally imbibed with an ion conductive material such as phosphoric acid (PA). In this form, such membranes are sometimes referred to as acid doped PBI membranes, or simply “PBI.” PBI membranes produced under the sol-gel process can have more than 20 moles of PA per PBI repeating unit (e.g., 20-40 moles of PA per PBI repeating unit), which is believed to be higher than what is currently achievable using non-sol-gel methods.

Without wishing to be bound by theory, it is believed that the higher PA loading in PBI membranes results in greater proton conductivity. As examples, such membranes generally have conductivities of at least 0.1 S/cm, or even at least 0.2 S/cm.

An electrochemical cell can be operated in a pumping mode by placing an electrical potential across the electrodes. The first electrode, generally referred to as the anode, has a higher electric potential with respect to zero than the second electrode, which is generally referred to as the cathode. The anode is contacted with hydrogen, which is ionized and subsequently evolved at the cathode as described above. The hydrogen gas can be pure hydrogen, or a mixed gas containing any amount of hydrogen. The hydrogen gas may be referred to synonymously as a source gas, hydrogen source gas, hydrogen containing gas, etc.

The direction of hydrogen “pumping” across the membrane can be controlled according to the polarity of the electrical potential between the first and second electrodes. The hydrogen flows between the electrodes from higher to lower potential with respect to ground or zero. Thus, reversing the polarity across the cell can reverse the direction of hydrogen flow between the electrodes. In this context, “reversing a direction” is taken to mean selectively evolving hydrogen at either electrode according to the polarity of the potential that is applied to the cell.

It is noted that the designations of “anode” and “cathode” can be misleading in pumping cells where the polarity is sometimes reversed. Thus, the electrodes are sometimes alternately referred to as “first” and “second.”

As an example, the invention provides a method of operating an electrochemical cell in a hydrogen pumping mode, comprising steps including the following: applying an electrical potential between a first electrode and a second electrode of the cell; wherein the first electrode has a higher electrical potential with respect to zero than the second electrode; flowing electrical current through the cell to consume electrical power; wherein the first and second electrodes have an acid doped polybenzimidazole membrane between them; ionizing hydrogen at the first electrode; evolving hydrogen at the second electrode; and contacting the first electrode or the second electrode with H2O to decrease the electrical power consumed. In the context of this invention, references to H2O indicate H2O in the vapor phase unless otherwise indicated. Both vapor and liquid H2O can be used to hydrate cells, but vapor humidification is generally preferred.

As another example, the invention provides a method of operating an electrochemical cell in a hydrogen pumping mode, comprising steps including the following: applying an electrical potential between a first electrode and a second electrode of the cell; wherein the first electrode has a higher electrical potential with respect to zero than the second electrode; flowing electrical current through the cell to consume electrical power; wherein the first and second electrodes have an acid doped polybenzimidazole membrane between them; ionizing hydrogen at the first electrode; evolving a hydrogen output flow at the second electrode; wherein the cell has a ratio of (electrical power consumed) to (hydrogen output flow); and contacting the first electrode or the second electrode with H2O to decrease the ratio of (electrical power consumed) to (hydrogen output flow).

As another example, the invention provides a method of operating an electrochemical cell in a hydrogen pumping mode, comprising steps including the following: applying an electrical potential between a first electrode and a second electrode of the cell; wherein the first electrode has a higher electrical potential with respect to zero than the second electrode; flowing electrical current through the cell to consume electrical power; wherein the first and second electrodes have an acid doped polybenzimidazole membrane between them; ionizing hydrogen at the first electrode; evolving a hydrogen output flow at the second electrode; and contacting the first electrode or the second electrode with H2O to maintain the hydrogen output flow while decreasing the electrical potential between the first electrode and second electrode.

It is noted that, whereas each of the forgoing methods are defined in terms of utilizing a PBI proton exchange membrane, other proton exchange membranes can also be used, such as Nafion®, PEEK, etc. The various features and optionally added steps can also be used with such systems.

The relative humidity of the hydrogen ionized at the first electrode can be anywhere from slightly unsaturated to completely dry. In general, an approximately dry condition is defined in this context as a relative humidity less than 0.1%. As an example, the relative humidity of such a gas can be increase to a desired threshold such as greater than 0.1%, 0.5%, 1.0%, 10%, etc. As an example, it has been found that raising the relative humidity of dry hydrogen to about 0.5% for a cell running at 160 C can provide a substantial drop in power required to operate the cell. It will be appreciated that higher relative humidities at higher temperatures such as over 100 C (e.g., 160 C) may be difficult or impossible to obtain without pressurization. The invention also covers embodiments where the hydrogen being humidified is at higher than atmospheric pressure, or is pressurized as a step in conditioning the gas for use. In pressurized systems, it may be desirable in some cases to provide higher relative humidities, such as 15% or greater, 20% or greater, 40% or greater, or 60% or greater.

As a result of such methods, the electrical power consumed by the cell can be decreased by a desired amount, such as 10%, 15%, 20%, 25%, 30%, 35%, 40%, 45% or 50%. The amount of hydration contributed to the cell can be correlated to a desired reduction in operating power for a given set of operating parameters, or hydration can be increased until a desired decrease in operating power is achieved. This may also be reflected in the operating voltage of the cell that can be achieved. In some embodiments, a cell can be operated under the present invention at voltages less than 0.8 volts, less than 0.6 volts, or even less than 0.3 volts.

It will be appreciated that the method of hydrating the cell can include introducing H2O at the anode or cathode. This H2O can be in the form of water vapor or liquid water.

In another embodiment, the method of hydrating the cell can include adding oxygen (e.g., air) to the hydrogen gas at the anode. The oxygen is then reacted at the anode with oxygen to form water, which in turn hydrates the cell. As an example, if hydrogen is saturated at room temperature (70 F), then the partial pressure of water vapor in the stream is about 2.5% of atmospheric pressure. In order to create that amount of water from the reaction of oxygen from air, at least 1.2% of the input hydrogen stream must be oxygen, since each O2 molecule makes 2 H2O molecules, assuming nearly complete conversion of oxygen to water. Since oxygen is about one fifth the composition of air, then about 6% air bleed (ratio of air bleed flow to hydrogen flow) is necessary to saturate the anode inlet hydrogen stream. A substantially lower amount of hydration may actually be required to obtain the performance increase described herein.

In such embodiments, it is generally desirable to maintain air bleed as low as possible, not only for safety reasons, since elevated oxygen levels can create a flammable mixture (upper flammability limit of hydrogen in air is approximately 75%), but also for efficiency reasons, since such oxygen consumes a portion of the hydrogen. In addition, such inert gases encountered in air will cause a slight blanketing over the anode catalyst, decreasing performance. However, this performance loss is actually quite small, since the Nernst overpotential in this case is about 43 mV/decade dilution of hydrogen at 160 C, or about 1 mV loss for 6% air bleed.

Such an embodiment includes the methods previously discussed, wherein the step of contacting the first electrode or the second electrode with H2O comprises: injecting air into a hydrogen source gas to raise an air content of the hydrogen source gas to within the range of 1-6% on a molar basis; and contacting the first electrode with the hydrogen source gas.

As another approach for general methods provided under the invention, the step of contacting the first electrode or the second electrode with H2O can comprise: replacing the electrical potential between the first and second electrodes with an electrical load, and then replacing the electrical load with the electrical potential. It will be appreciated that in this context, “electrical load” refers to essentially any electrical connection that is placed between the electrodes where current is removed. As an example, this can refer to operation of the cell as a fuel cell.

As previously indicated, in certain embodiments, the proton exchange membranes used under the present invention can include those based on PBI materials. Where such “high temperature” membranes are used, it is generally desirable to maintain them at an operating temperature of at least 100 C, such as 140 C or higher, or 160 C or higher.

Where PBI membranes are used, it is generally desirable to initiate operation with a membrane imbibed with phosphoric acid at a ratio of at least 20 moles phosphoric acid to polybenzimidazole repeating unit, or greater than 32 moles phosphoric acid to polybenzimidazole repeating unit, or even at least 40 moles phosphoric acid to polybenzimidazole repeating unit. It is also generally preferable that PBI materials be those formed from the sol-gel process. As additional preferred selective parameters

It is also generally preferable to use a proton exchange membrane having a proton conductivity that is as high as possible. For example, membranes preferred under the present invention are those having a proton conductivity of at least 0.1 S/cm, including those having a proton conductivity of at least 0.2 S/cm.

Methods under the present invention can include aspects related to specific implementations, including control and automation. As an example, methods under the present invention can further include a step comprising: measuring an electrical performance parameter of the cell; and generating a control signal when the electrical performance parameter exceeds a predetermined value; wherein the step of contacting the first electrode or the second electrode with H2O to decrease the electrical power consumed is performed upon generation of the control signal. As examples, the performance parameter can be the electrical potential between the first electrode and second electrode, the electrical current flow through the cell, the electrical power consumed by the cell, or a ratio of (electrical power consumed by the cell) to (hydrogen evolved at the second electrode).

In some embodiments, the methods discussed herein can be implemented periodically. As one possible example, a cell can be intermittently pulsed with H2O to improve performance as needed. A controller can be provided to monitor an electrical performance variable of the cell, such as voltage, or current or power consumption. When the variable falls below a predetermined threshold, one of the foregoing methods can be implemented to improve performance by hydrating the cell. The hydration step can be performed for a predetermined period of time, or by any other measurement, including monitoring the performance variable to stop the hydration step when the variable rises over a predetermined threshold.

Whereas the embodiments and features discussed herein are generally described with respect to individual cells, it will be appreciated that they are also applicable to cells grouped in stack configurations. Descriptions as to the operation of individual cells can thus be taken to cover cells by themselves, or a cell forming part of a stack configuration.

### EXAMPLE 1

A 50 cm2 cell with an active area of 45 m2 was constructed using graphite flow plates with a double serpentine flow field on the anode and a triple serpentine flow field on the cathode, and using a commercially available Celtec P-1000 membrane electrode assembly purchased from Pemeas Fuel Cell Technologies.

The cell was maintained at approximately 160 C. A power supply was connected across the flow field plates. Dry hydrogen at essentially atmospheric pressure was flowed to the higher voltage side of the membrane (anode) at approximately 1.2 stoichiometry (“stoich”), while approximately 0.2 A/cm2 of current was utilized from the power supply. In one test, the dry hydrogen at the anode was saturated with water vapor, resulting in an immediate reduction of operating voltage from 25-30 mV to 15 mV, thus significantly reducing the power required to operate the cell.

### EXAMPLE 2

A cell as described in Example 1 was heated to 160 C with a hydrogen flow on the anode side of 1.1 stoich without humidifying the hydrogen feed stream. The hydrogen was essentially dry. After more than 500 hours of operation, the cell voltage was 46 mV. The cell was then humidified by passing the hydrogen feed gas through a humidification bottle that was set for a dew point of 23 C, which corresponds to a 0.5% relative humidity (“RH”) at 160 C. After 24 hours of operation, the cell voltage was recorded at 40 mV, which corresponds to an approximately 13% decrease in power required to operate the cell. The humidification bottle on the hydrogen feed stream was then reset to 30 C dew point, which corresponds to 0.7% RH at the electrode (160 C). After 24 hours of operation, the cell voltage was 35 mV, which corresponds to a 24% drop in power relative to the dry operation.

### EXAMPLE 3

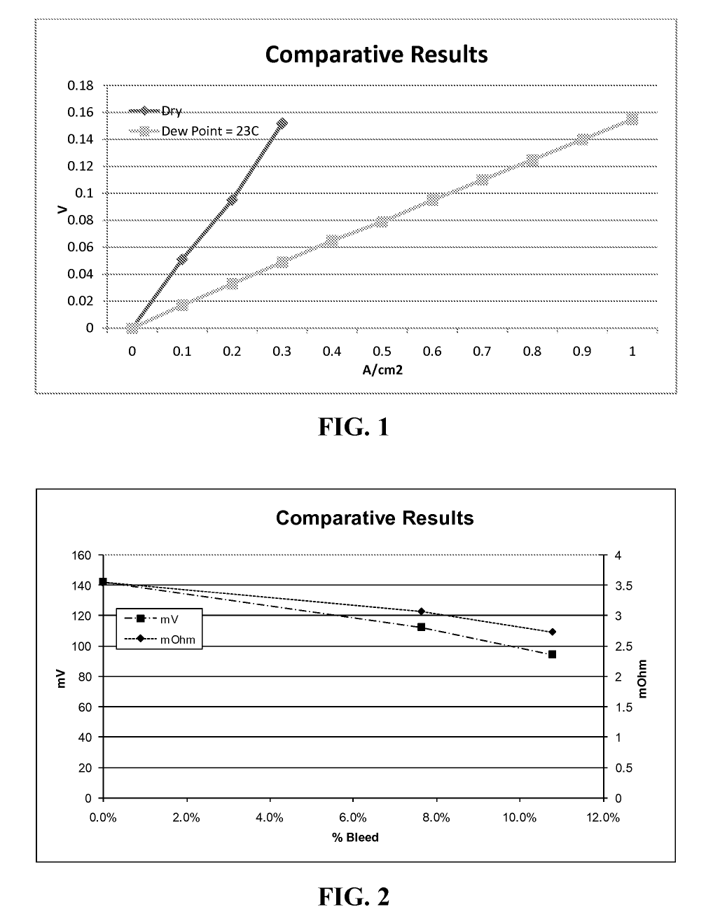

In this example, two cells were constructed as in Example 1, and heated to 160 C under 1.1 stoich of hydrogen flow rate at 0.2 A/cm2 for 24 hours. For one of the cells, the hydrogen feed stream was placed into a humidification bottle set at a 23 C dew point which corresponds to a 0.5% RH at the electrode (160 C). The cells were then run for another 24 hours after which the polarization curves of both cells were recorded as shown in FIG. 1. It can be seen that the power decreases described herein can be observed over a broad range of current densities.

### EXAMPLE 4

A cell was constructed as described in Example 1 and run at 160 C at 0.2 A/cm2 with 1.1 stoich dry hydrogen for more than 500 hours. The cell voltage was measured at 142 mV. A metered valve was then connected to the hydrogen feed stream to allow the introduction of air into the hydrogen feed stream. When the amount of air bleed in the hydrogen feed stream to the anode was 7.6 vol %, which corresponds to an approximately 3% RH at the electrode, the cell voltage decreased to 112 mV, corresponding to a decrease of approximately 21% in the power required to operate the cell. The amount of air bleed was then increased to 10.8 vol % in the hydrogen feed stream, which corresponds to approximately 5% RH at the electrode. After 24 hours the voltage was measured at 94 mV, which corresponds to an overall decrease in power of approximately 34% as compared to the dry operation. The results are shown in FIG. 2.

Discussion in the present case is generally made with respect to particular aspects of electrochemical cell technologies affected by the concepts reflected in the claims. Basic construction and operating techniques for electrochemical cells are well known in the art. As examples, various suitable designs and operating methods that can be used as a base to implement the present invention are described in the teachings of U.S. Pat. Nos. 4,620,914; 6,280,865; 7,132,182 and published U.S. patent application Ser. No. 10/478,852, which are each hereby incorporated by reference in their entirety.

While the invention has been shown or described in only some of its forms, it should be apparent to those skilled in the art that it is not so limited, but is susceptible to various changes without departing from the scope of the invention.

We claim:

1. A method of operating an electrochemical cell in a hydrogen pumping mode, comprising:
applying an electrical potential between a first electrode and a second electrode of the cell;
wherein the first electrode has a higher electrical potential with respect to zero than the second electrode;
flowing electrical current through the cell to consume electrical power;
wherein the first and second electrodes have an acid doped polybenzimidazole membrane between them;
ionizing hydrogen at the first electrode;
evolving hydrogen at the second electrode; and
contacting the first electrode or the second electrode with H2O to decrease the electrical power consumed.

2. The method of claim 1, wherein a relative humidity of the hydrogen ionized at the first electrode is less than 0.1% prior to performing the step of contacting the first electrode or the second electrode with H2O to decrease the electrical power consumed.

3. The method of claim 1, wherein the step of contacting the first electrode or the second electrode with H2O to decrease the electrical power consumed comprises raising a relative humidity of the hydrogen ionized at the first electrode from less than 0.1% to greater than 0.1%.

4. The method of claim 1, wherein the step of contacting the first electrode or the second electrode with H2O to decrease the electrical power consumed comprises raising a relative humidity of the hydrogen ionized at the first electrode from less than 0.5% to greater than 0.5%.

5. The method of claim 1, wherein the step of contacting the first electrode or the second electrode with H2O to decrease the electrical power consumed comprises raising a relative humidity of the hydrogen ionized at the first electrode from less than 1.0% to greater than 1.0%.

6. The method of claim 1, wherein the electrical power consumed is decreased by a factor of at least 10%.

7. The method of claim 1, wherein the electrical power consumed is decreased by a factor of at least 50%.

8. The method of claim 1, wherein the electrical potential is maintained at less than 0.8 volts.

9. The method of claim 1, wherein the electrical potential is maintained at less than 0.6 volts.

10. The method of claim 1, wherein the electrical potential is maintained at less than 0.3 volts.

11. The method of claim 1, wherein the step of contacting the first electrode or the second electrode with H2O comprises contacting the cell with H2O vapor.

12. The method of claim 1, wherein the step of contacting the first electrode or the second electrode with H2O comprises humidifying a hydrogen source gas and contacting the first electrode with the hydrogen source gas.

13. The method of claim 1, wherein the step of contacting the first electrode or the second electrode with H2O comprises injecting oxygen into a hydrogen source gas and contacting the first electrode with the hydrogen source gas.

14. The method of claim 1, wherein the step of contacting the first electrode or the second electrode with H2O comprises:
injecting air into a hydrogen source gas to raise an air content of the hydrogen source gas to within the range of 1-6% on a molar basis; and
contacting the first electrode with the hydrogen source gas.

15. The method of claim 1, wherein the step of contacting the first electrode or the second electrode with H2O comprises replacing the electrical potential between the first and second electrodes with an electrical load, and then replacing the electrical load with the electrical potential.

16. The method of claim 1, further comprising;
measuring an electrical performance parameter of the cell;
generating a control signal when the electrical performance parameter exceeds a predetermined value;
wherein the step of contacting the first electrode or the second electrode with H2O to decrease the electrical power consumed is performed upon generation of the control signal.

17. The method of claim 16, wherein the performance parameter is the electrical potential between the first electrode and second electrode.

18. The method of claim 16, wherein the performance parameter is the electrical current flow through the cell.

19. The method of claim 16, wherein the performance parameter is the electrical power consumed by the cell.

20. The method of claim 16, wherein the performance parameter is a ratio of (electrical power consumed by the cell) to (hydrogen evolved at the second electrode).

21. The method of claim 1, wherein the cell is maintained at a temperature of at least 100 C.

22. The method of claim 1, wherein the cell is maintained at a temperature of at least 140 C.

23. The method of claim 1, wherein the membrane comprises phosphoric acid at a ratio of at least 20 moles phosphoric acid to polybenzimidazole repeating unit.

24. The method of claim 1, wherein the membrane comprises phosphoric acid at a ratio of at least 32 moles phosphoric acid to polybenzimidazole repeating unit.

25. The method of claim 1, wherein the membrane comprises phosphoric acid at a ratio of at least 40 moles phosphoric acid to polybenzimidazole repeating unit.

26. The method of claim 1, wherein the membrane is prepared by a sol-gel process.

27. The method of claim 1, wherein the membrane has a proton conductivity of at least 0.1 S/cm.

28. The method of claim 1, wherein the membrane has a proton conductivity of at least 0.2 S/cm.

29. A method of operating an electrochemical cell in a hydrogen pumping mode, comprising:
applying an electrical potential between a first electrode and a second electrode of the cell;
wherein the first electrode has a higher electrical potential with respect to zero than the second electrode;
flowing electrical current through the cell to consume electrical power;
wherein the first and second electrodes have an acid doped polybenzimidazole membrane between them;
ionizing hydrogen at the first electrode;
evolving a hydrogen output flow at the second electrode;
wherein the cell has a ratio of (electrical power consumed) to (hydrogen output flow); and
contacting the first electrode or the second electrode with H2O to decrease the ratio of (electrical power consumed) to (hydrogen output flow).

30. A method of operating an electrochemical cell in a hydrogen pumping mode, comprising:
applying an electrical potential between a first electrode and a second electrode of the cell;
wherein the first electrode has a higher electrical potential with respect to zero than the second electrode;
flowing electrical current through the cell to consume electrical power;
wherein the first and second electrodes have an acid doped polybenzimidazole membrane between them;
ionizing hydrogen at the first electrode;
evolving a hydrogen output flow at the second electrode; and
contacting the first electrode or the second electrode with H2O to maintain the hydrogen output flow while decreasing the electrical potential between the first electrode and second electrode.

31. A method of operating an electrochemical cell in a hydrogen pumping mode, comprising:
applying an electrical potential between a first electrode and a second electrode of the cell;
wherein the first electrode has a higher electrical potential with respect to zero than the second electrode;
flowing electrical current through the cell to consume electrical power;
wherein the first and second electrodes have a proton exchange membrane between them;
ionizing hydrogen at the first electrode;
evolving hydrogen at the second electrode; and
contacting the first electrode or the second electrode with H2O to decrease the electrical power consumed.

32. The method of claim 31, wherein a relative humidity of the hydrogen ionized at the first electrode is less than 1% prior to performing the step of contacting the first electrode or the second electrode with H2O to decrease the electrical power consumed.

33. The method of claim 31, wherein the electrical power consumed is decreased by a factor of at least 10%.

34. The method of claim 31, wherein the electrical power consumed is decreased by a factor of at least 50%.

35. The method of claim 31, wherein the step of contacting the first electrode or the second electrode with H20 comprises humidifying a hydrogen source gas and contacting the first electrode with the hydrogen source gas.

36. The method of claim 31, wherein the step of contacting the first electrode or the second electrode with H2O comprises injecting oxygen into a hydrogen source gas and contacting the first electrode with the hydrogen source gas.

37. The method of claim 31, wherein the step of contacting the first electrode or the second electrode with H2O comprises:
injecting air into a hydrogen source gas to raise an air content of the hydrogen source gas to within the range of 1-6% on a molar basis; and
contacting the first electrode with the hydrogen source gas.

38. The method of claim 31, wherein the step of contacting the first electrode or the second electrode with H2O comprises replacing the electrical potential between the first and second electrodes with an electrical load, and then replacing the electrical load with the electrical potential.

39. The method of claim 31, further comprising;
measuring an electrical performance parameter of the cell;
generating a control signal when the electrical performance parameter exceeds a predetermined value;
wherein the step of contacting the first electrode or the second electrode with H2O to decrease the electrical power consumed is performed upon generation of the control signal.

40. The method of claim 39, wherein the performance parameter is the electrical potential between the first electrode and second electrode.

41. The method of claim 39, wherein the performance parameter is the electrical current flow through the cell.

42. The method of claim 39, wherein the performance parameter is the electrical power consumed by the cell.

43. The method of claim 39, wherein the performance parameter is a ratio of (electrical power consumed by the cell) to (hydrogen evolved at the second electrode).
